(19) United States
(12) Patent Application Publication
(10) Pub. No.: US 2014/0259040 A1
(43) Pub. Date: Sep. 11, 2014

(54) METHODS AND APPARATUSES FOR DEDUCING A VIEWING HOUSEHOLD MEMBER PROFILE

(71) Applicant: ELECTRONICS AND TELECOMMUNICATIONS RESEARCH INSTITUTE, DAEJEON (KR)

(72) Inventors: Kyeong Soo HAN, Daejeon (KR); Han Kyu LEE, Daejeon (KR)

(73) Assignee: ELECTRONICS AND TELECOMMUNICATIONS RESEARCH INSTITUTE, DAEJEON (KR)

(21) Appl. No.: 14/165,412

(22) Filed: Jan. 27, 2014

(30) Foreign Application Priority Data
Mar. 6, 2013 (KR) 10-2013-0023752

(51) Int. Cl. H04N 21/25; H04N 21/45

(52) U.S. Cl. CPC H04N 21/252; H04N 21/4532
USPC 725/14

(57) ABSTRACT

Disclosed is a method and apparatus for deducing a viewing household member profile. According to the method and apparatus, a viewing pattern of a general viewing household is analyzed based on viewer group classification criteria generated using the standard household member profile, and thus the member profile of the viewing household may be deduced and the deduced profile may be provided, thereby effectively providing advertisements corresponding to the inclination of viewing household members.

Priority to Korean patent application number 10-2013-0023752 filed on Mar. 6, 2013, the entire disclosure of which is incorporated by reference herein, is claimed.

### BACKGROUND OF THE INVENTION

1. Field of the Invention

The present invention relates to method of providing a broadcast service, and more particularly, to a method of deducing consumer characteristics of a broadcast service.

2. Discussion of the Related Art

Recently, as digital broadcasting is widely distributed, interest in a customized advertisement service is on the increase in addition to a simple exposed advertisement service. Advertisements are inserted and provided before and after a video on demand (VoD) service in IPTV, etc., and there have been some attempts to make the advertisements customized. As technologies for smart TVs including a hybrid TV where Internet and ground wave are integrated as well as IPTV are developed, the TVs have two way characteristics that allow mutual communication with TV viewers unlike the existing ground wave broadcasts, and thus viewer-customized advertisements using such characteristics may be possible.

Generally, an advertiser presents a demographic profile of target consumers of a product to be advertised, such as gender and ages, as advertisement requirements. However, a broadcast company that broadcasts advertisements or an advertisement agency that plans and broadcasts advertisements does not know a demographic profile of viewers. Hence, the advertisement agency plans and broadcasts advertisements at broadcast contents viewed by many target consumers based on statistics on the program rating and the past experience.

An advertisement is generally a means for advertising a product. The advertisement of a product is effective when the product is advertised to target customers. Advertisers such as companies and advertisement agencies desire to expose their advertisement to as many target customers as possible.

The broadcast advertisement occupies the highest portion of all forms of advertisements and requires a lot of costs, but there is a limit in terms of targeting advertisements. In the case of the ground wave broadcast advertisement, the advertisement is exposed to all viewers of a certain program by a broadcast, and thus the targeting advertisement is not possible in the ground wave broadcast. However, in the VoD service of an IPTV, a smart TV (Apple i-TV, Google TV, Daum TV, etc.) or over-the-top (OTT), etc., contents are individually transmitted when there is a VoD request, and advertisements are inserted before, in the middle of, or after the contents. In this case, it is possible to send different advertisements to different viewers.

There have been various attempts for the targeting advertisements, but the broadcast company that transmits advertisements or the advertisement agency that plans and transmits advertisements does not know the demographic profile of viewers. Hence, the advertisement agency plans and transmits advertisements at the broadcast contents which they think more target consumers view, based on the statistics on the program rating and the past experience.

Furthermore, generally, the VoD service provider knows only the profile of representative subscribers, and cannot know the profile of family members of the subscribers. Furthermore, the information on the representative subscribers cannot be utilized as information for advertisement due to the laws related with personal information protection.

### SUMMARY OF THE INVENTION

An object of the present invention is to provide a method of deducing the profile of members of a viewing household that receives a broadcast service.

In accordance with an aspect of the present invention, a method of deducing a member profile of a viewing household includes deducing the member profile of the viewing household using viewer group classification criteria.

The deducing may further include generating the viewer group classification criteria using a viewing pattern according to a viewer group.

The deducing may further include analyzing a viewing pattern performing using a viewing pattern of a viewing household whose member profile is already known.

The analyzing may include analyzing the viewing pattern of the viewer group formed by grouping viewers by profile attributes of the viewers.

The generating may include generating a difference in a viewing pattern between the viewer groups, generating a characteristic viewing pattern of the viewer groups, and generating the viewer group classification criteria using the characteristic viewing pattern.

The generating the difference may include generating the difference in the viewing pattern between the viewer groups by classifying the viewer groups using the viewing pattern between the viewer groups and a decision tree.

The generating of the characteristic viewing pattern may include determining common attributes shown in respective viewing pattern differences as characteristic viewing patterns in respective viewing pattern differences shown in one to one correspondence between a first viewer group and one or more other viewer groups.

The generating of the viewer group classification criteria may include generating the viewer group classification criteria of the viewer group using the characteristic viewing pattern which belongs to the viewer group and does not belong to other viewer groups.

The deducing may include deducing the member profile of the viewing household by finding viewer group classification criteria corresponding to a viewing history of the viewing household.

The deducing the member of the viewing household may include using viewing history attributes to which the two or more viewer group classification criteria are not applied among the viewing history attributes of the viewing household, as a data set for deducing the viewer profile.

In accordance with another aspect of the present invention, an apparatus for deducing a member profile of a viewing household includes a viewing household member profile generation unit that deduces the member profile of the viewing household using viewer group classification criteria.

The viewing household member profile generation unit may include a viewer group classification criteria generation unit that the viewer group classification criteria according to a viewing pattern of a viewer group, and a viewing household member profile deduction apparatus that deduces a member profile of the viewing household using the viewer group classification criteria.

The viewing household member profile generation unit may further include a viewing pattern analysis unit that analyzes the viewing pattern of the viewing household using the viewing pattern of the viewing household whose member profile is already known.

The viewing pattern analysis unit may include analyzing a viewing pattern of viewer groups in which viewers have been grouped according to profile attributes of the viewers.

The viewer group classification criteria generation unit may generate the viewer group classification criteria using a characteristic viewing pattern of the viewer group generated using a viewing pattern difference between the viewer groups.

The viewer group classification criteria generation unit may generate a difference in a viewing pattern between the viewer groups by classifying the viewer groups using the viewing pattern between the viewer groups and a decision tree.

The viewer group classification criteria generation unit may determine common attributes shown in respective viewing pattern differences as characteristic viewing patterns of the viewer group in respective viewing pattern differences shown in one to one correspondence between a first viewer group and one or more other viewer groups.

The viewer group classification criteria generation unit may generate the viewer group classification criteria of the viewer group using a characteristic viewing pattern which belongs to the viewer group and does not belong to other viewer groups.

The member profile deduction unit may deduce the member profile of the viewing household by finding viewer group classification criteria corresponding to a viewing history of the viewing household.

The member profile deduction unit may use viewing history attributes to which the two or more viewer group classification criteria are not applied among the viewing history attributes of the viewing household, as a data set for deducing the viewer profile.

### BRIEF DESCRIPTION OF THE DRAWINGS

FIG. 1 is a block diagram of an apparatus for deducing a viewing household member profile according to an embodiment of the present invention;

FIG. 2 is a flowchart illustrating operation of an apparatus for deducing a viewing household member profile according to an embodiment of the present invention;

FIG. 3 is a flowchart illustrating operation of analyzing a viewing pattern of a standard household of an apparatus for deducing a viewing household member profile according to an embodiment of the present invention;

FIG. 4 is a flowchart illustrating operation of generating criteria for classifying viewer groups of an apparatus for deducing a viewing household member profile according to an embodiment of the present invention;

FIG. 5 is a flowchart illustrating operation of deducing a viewing household member profile of an apparatus for deducing a viewing household member profile according to an embodiment of the present invention;

FIG. 6 is a flowchart illustrating operation of utilizing a viewing household profile of an apparatus for deducing a viewing household member profile according to an embodiment of the present invention;

FIG. 7 is a conceptual diagram illustrating a method of generating a viewing pattern difference between viewer groups using a viewing pattern between viewer groups and a decision tree model by an apparatus for deducing a viewing household member profile according to an embodiment of the present invention;

FIG. 8 is a table showing a decision tree generation combination and characteristic viewing pattern between viewer groups generated according to viewer groups by a viewing household member profile deduction apparatus according to an embodiment of the present invention;

FIG. 9 is a diagram illustrating a viewing pattern of a viewing household input to an apparatus for deducing a viewing household member profile according to an embodiment of the present invention;

FIG. 10 is a diagram illustrating a characteristic viewing pattern of viewer group 1 generated by a viewing household profile deduction apparatus according to an embodiment of the present invention;

FIG. 11 is a diagram illustrating a characteristic viewing pattern of viewer group 2 generated by a viewing household profile deduction apparatus according to an embodiment of the present invention;

FIG. 12 is a diagram illustrating a method of applying the characteristic viewing pattern of viewer group 1 to the viewing household viewing pattern by a viewing household profile deduction apparatus according to an embodiment of the present invention; and

FIG. 13 is a diagram illustrating a method of applying the characteristic viewing pattern of viewer group 2 to the viewing household viewing pattern by a viewing household profile deduction apparatus according to an embodiment of the present invention.

### DETAILED DESCRIPTION OF THE EMBODIMENTS

Hereinafter, embodiments of the present invention will be described in detail with reference to the accompanying drawings so that they can be readily implemented by those skilled in the art.

Hereinafter, some embodiments of the present invention are described in detail with reference to the accompanying drawings in order for a person having ordinary skill in the art to which the present invention pertains to be able to readily implement the invention. It is to be noted the present invention may be implemented in various ways and is not limited to the following embodiments. Furthermore, in the drawings, parts not related to the present invention are omitted in order to clarify the present invention and the same or similar reference numerals are used to denote the same or similar elements.

The objects and effects of the present invention can be naturally understood or become clear by the following description, and the objects and effects of the present invention are not restricted by the following description only.

The objects, characteristics, and merits will become more apparent from the following detailed description. Furthermore, in describing the present invention, a detailed description of a known art related to the present invention will be omitted if it is deemed to make the gist of the present invention unnecessarily vague. A preferred embodiment in accordance with the present invention is described in detail below with reference to the accompanying drawings.

The term “include” in the present specification does not exclude other components which are not described here unless specifically disclosed otherwise, and may further include other components. Furthermore, the term “ . . . unit” refers to a unit for processing at least one function or operation, and may be implemented by hardware, software or a combination thereof.

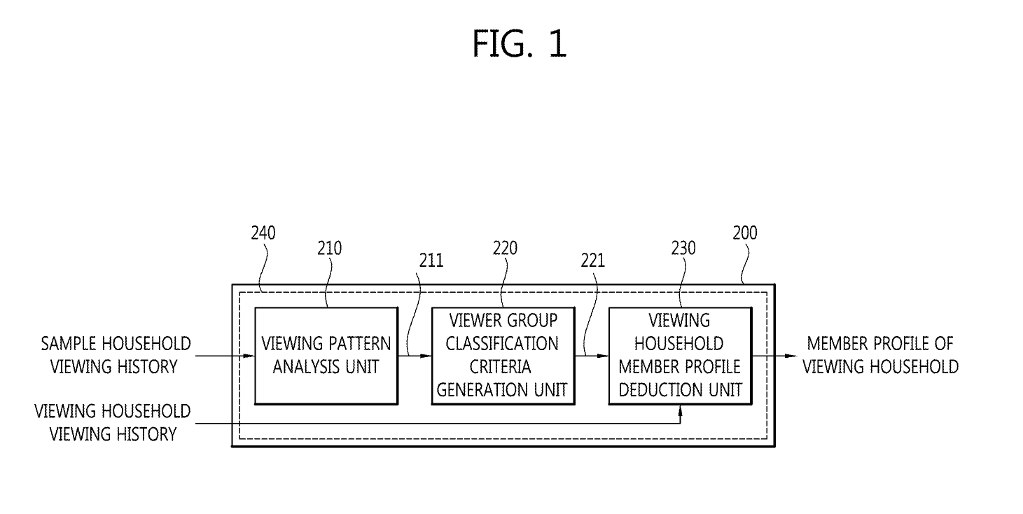

FIG. 1 is a block diagram of an apparatus 200 for deducing a viewing household member profile according to an embodiment of the present invention. The apparatus 200 for deducing a viewing household member profile according to an embodiment of the present invention includes a viewing household member profile generation unit 240, and the viewing household member profile generation unit 240 includes a viewing pattern analysis unit 210, a viewer group classification criteria generation unit 220, and a viewing household member profile deduction unit 230. The viewing pattern analysis unit 210, the viewer group classification criteria generation unit 220, and the viewing household member profile deduction unit 230 may be implemented as one module or two or more modules, or may be implemented as respective modules.

The viewing pattern analysis unit 210 receives a sample household viewing history to analyze the viewing pattern of the sample household. The sample household is a viewer household whose member profile is known, and the household member profile includes genders, ages, occupations, tastes, life patterns of members and the number of the members. The viewing history of the sample household may be distinguished by households and viewers.

Generally, when the viewer's gender or ages are the same or similar, a similar viewing pattern is shown. As such, the viewing pattern analysis unit 210 groups respective views of the sample household by profile attributes of household members, such as gender or ages so as to analyze the viewing pattern for each group. The result of the viewing pattern analysis may be shown in various forms such as the viewing time by days of the week, the viewing time by time zones, genre preference by days of the week, genre preference by time zones, etc. The viewing pattern analysis unit 210 transmits the viewing pattern of the analyzed sample household to the viewer group classification criteria generation unit 220.

The viewer group classification criteria generation unit 220 receives the viewing pattern of the sample household to generate the viewer group classification criteria. The viewer group classification criteria are generated using a certain viewing pattern for each viewer group, which is generated using the viewing pattern of the sample household. The viewer group classification criteria generation unit 220 transmits the generated viewer group classification criteria to the viewing household member profile deduction unit 230.

The viewing household member profile deduction unit 230 deduces the member profile of the viewing household using the viewer group classification criteria received from the viewer group classification criteria generation unit 220 and the received viewing household viewing history.

The apparatus 200 for deducing a viewing household member profile according to an embodiment of the present invention may utilize the viewing house hold member profile deduced including the module that utilizes the deduced viewing household member profile as in a module for providing targeting advertisements, or may be connected to the module that utilizes the deduced viewing household member profile and provide the deduced viewing household member profile.

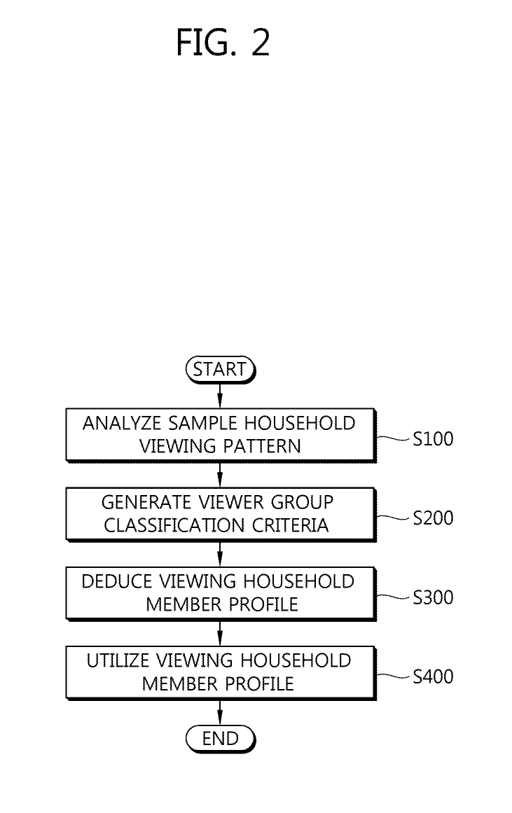

FIG. 2 is a flowchart illustrating operation of an apparatus 200 for deducing a viewing household member profile according to an embodiment of the present invention. The apparatus 200 for deducing a viewing household member profile according to an embodiment of the present invention may perform a sample household viewing pattern analysis operation (S100), a viewer group classification criteria generation operation (S200), a viewing household member profile deduction operation (S300), and a viewing household member profile utilization operation (S400).

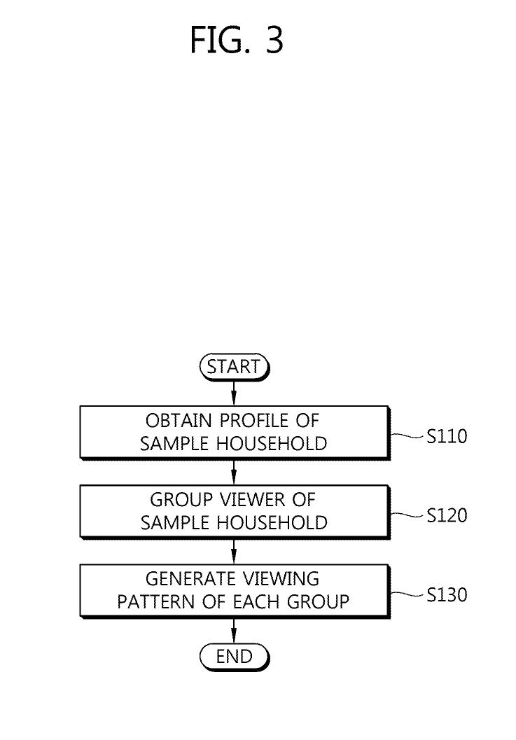

FIG. 3 is a flowchart illustrating operation (S100) of analyzing a viewing pattern of a standard household of an apparatus 200 for deducing a viewing household member profile according to an embodiment of the present invention. Hereinafter, the sample household viewing pattern analysis operation (S100) will be described with reference to FIG. 3. First, the profile of the sample household needs to be obtained (S110). The viewing pattern analysis unit 210 receives the sample household member profile and viewing history. Thereafter, the viewer grouping of the sample household is performed (S120). The viewing pattern analysis unit 210 groups respective views of the sample household according to certain attributes using the sample household member profile. Finally, the viewing pattern by groups is generated (S130). The viewing pattern analysis unit 210 generates the viewing pattern by viewer groups of the sample household. As a result of the viewing pattern analysis, the viewing time or genre preference, etc. by days of the week or time zones of groups having certain ages and gender may be deduced.

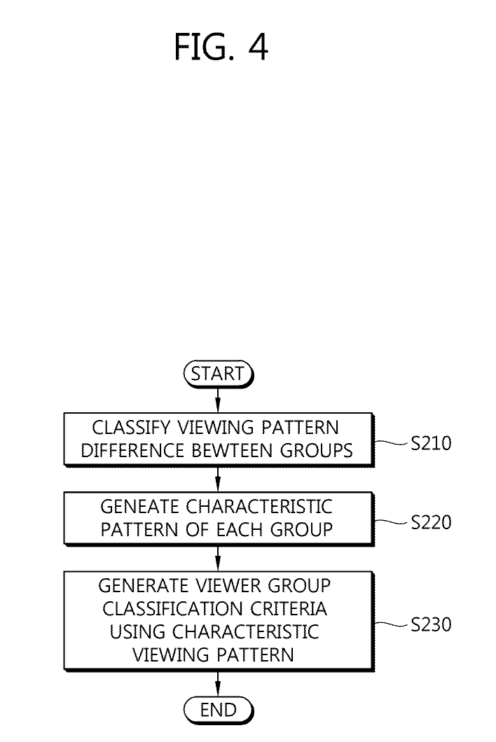

FIG. 4 is a flowchart illustrating operation of generating criteria for classifying viewer groups of an apparatus 200 for deducing a viewing household member profile according to an embodiment of the present invention. Hereinafter, the process of generating criteria for classifying viewer groups by the apparatus 200 for deducing a viewing household member profile. First, the viewer group criteria generation unit 220 classifies the viewer pattern difference between viewer groups (S210). The difference in the viewing patterns between viewer groups may be specified by classifying the viewer groups using the viewing pattern attributes of the viewer groups. Here, the difference in the viewing patterns between respective viewing groups may be generated in a decision tree scheme among the classification schemes of data mining.

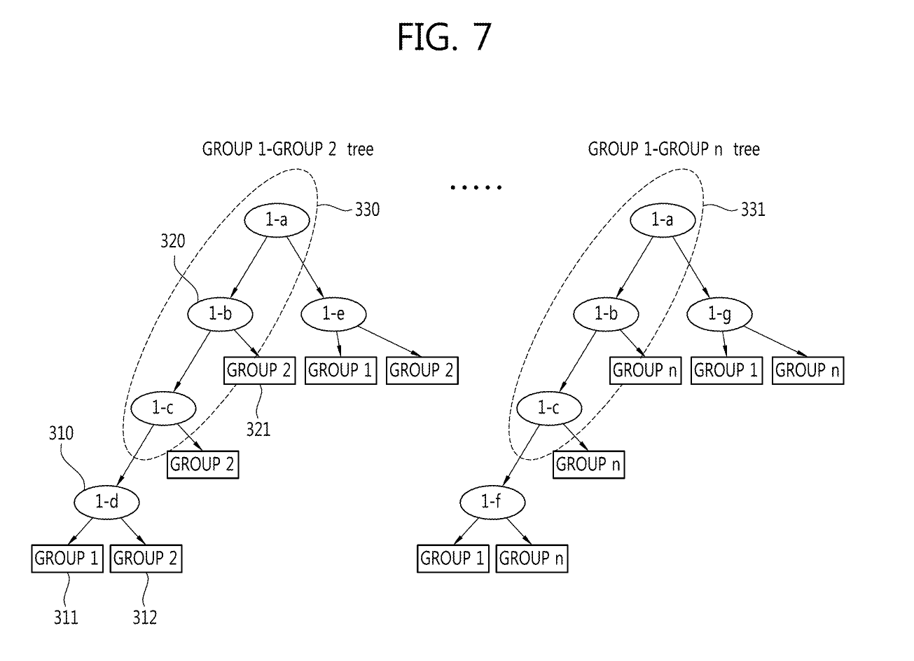

FIG. 7 is a conceptual diagram illustrating a method of generating a viewing pattern difference between viewer groups using a viewing pattern between viewer groups and a decision tree model by an apparatus 200 for deducing a viewing household member profile according to an embodiment of the present invention. The operation (S210) of generating a difference in a viewing pattern by viewer groups using a decision tree scheme by the viewer group classification criteria generation unit 220 will be described with reference to FIG. 7.

If the viewing pattern is analyzed by viewer groups of the sample household, the viewer group classification criteria generation unit 220 generates n−1 trees for each group by the decision tree scheme among classification schemes of data mining. The internal node expressed as a round node in the decision tree illustrated in FIG. 7 expresses attributes for distinguishing viewer groups. If the viewing pattern data value is a value corresponding to the attributes of the internal node, the classification of viewer groups may be performed by the right sub-tree, and if the viewing pattern data value is not a value corresponding to the attributes of the internal node, the classification of viewer groups may be performed by the left sub-tree. The attributes of the analyzed viewing pattern may be used as the attribute values of the internal node. The terminal node expressed as the rectangular node indicates the group of the viewers classified according the range by the value of the internal node.

The attributes of the analyzed viewing pattern may be used as the attributes of the decision tree. In the embodiment illustrated in FIG. 7, the number of viewer groups is n, the viewer groups include group 1, group 2, . . . , group n. The viewer group classification criteria generation unit 220 generates the decision tree indicating the one to one correspondence between the group and another group for each viewer group. For example, for group 1, the decision tree of group 1 and group 2 is generated to generate the difference in the viewing pattern of group 1 and group 2. Likewise, the decision tree of group 1 and group 3, the decision tree of group 1 and group 4, . . . , the decision tree of group 1 and group n are generated. The (n−1) decision trees are generated for other groups in a manner that is the same as that of generating the decision tree of group 1. The total number of generated trees is n(n−1).

The data input in the decision tree of group 1 and group 2 is viewing pattern analysis data of viewers who belong to group 1 and group 2. The result value of the decision tree is the number of the group to which the viewer belongs among group 1 and group 2. The attribute value at each node of the generated decision tree becomes the viewing pattern having a difference between group 1 and group 2.

Referring to the decision tree of groups 1 and 2 of FIG. 7, internal nodes 1-a, 1-b, . . . , 1-e are attributes for classifying groups 1 and 2, and the terminal nodes are result positions according to the classification. The terminal node 311 which is the left child of the internal node 310 having the attribute of 1-d has the value of group 1, which means that the viewer without the attribute values of 1-a, 1-b, 1-c, and 1-d belongs to group 1. The terminal node 312 which is the right child of the internal node 310 having the attribute of 1-d has the value of group 2, which means that the viewer, who does not have the attributes of 1-a, 1-b, and 1-c, but has the attribute of 1-d, belongs to group 2.

Likewise, the terminal node 321 which is the right child of the internal node 320 having has the value of group 2, which means that the viewer, who does not have the attribute of 1-a, but has the attribute of 1-b, belongs to group 2.

Next, the viewer group classification criteria generation unit 220 generates the characteristic viewing pattern of each group (S220). FIG. 7 shows classification attributes 330 and 331 that are commonly included in each of the n−1 trees in which group 1—group 2 tree, . . . , group 1—group n tree are generated for group 1. If attributes 1-a, 1-b, and 1-c commonly belong to the decision trees of group 1 or redundantly belong to several trees as in the nodes 330 having the attributes of 1-a, 1-b, and 1-c of group 1—group 2 trees and the nodes 331 having the attributes of 1-a, 1-b, and 1-c of group 1—group n trees, the attributes become a characteristic viewing pattern which is distinguished from other groups. Attributes 1-d and 1-e indicate the difference between group 1 and group 2, and 1-f and 1-g indicate the difference between group 1 and group n, but the attributes cannot be the characteristic which distinguishes group 1 from other groups. (n−1) trees are generated for groups other than group 1, and the commonly included attributes are extracted. The extracted attributes may be different attributes, and may be attributes which has a criterion value of the same pattern, but has a different criterion value.

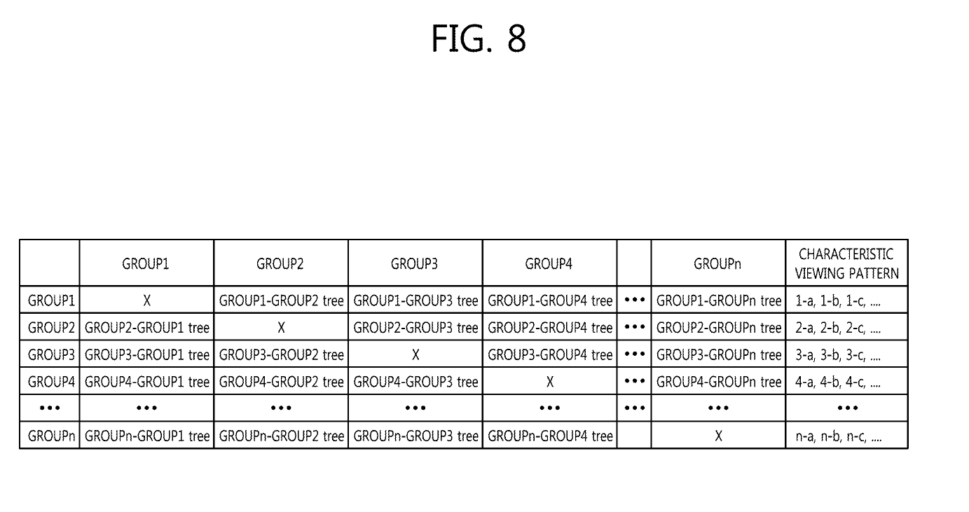

FIG. 8 is a table showing a decision tree generation combination and characteristic viewing pattern between viewer groups generated according to viewer groups by a viewing household member profile deduction apparatus 200 according to an embodiment of the present invention. FIG. 8 illustrates a decision tree form combined with other groups for group 1 and the characteristic viewing pattern of group 1, and also illustrates groups 2, 3, . . . , n.

The attribute values which are common or have been redundantly used in various decision trees among the attribute values used in the decision tree become the characteristic viewing pattern in terms of which group 1 is different form other groups. FIG. 8 shows a generation combination of the decision tree and the characteristic viewing pattern. The present invention extracts the characteristic viewing pattern for each viewer group using the decision tree in this step.

Finally, the viewer group classification criteria generation unit 220 generates the viewer group classification criteria for each group using the characteristic viewing pattern (S230). The respective classification criteria may prepared by the classifier which is formed by respective groups and respectively classifies the viewer corresponding to each group, or one classifier may deduce whether there is a viewer pattern that belongs to the group for all groups by one classifier. In this operation, the classification criteria may not use a decision tree scheme, but may use a general classification method.

In the previous operation, if n classification criteria are generated for each group by the generated characteristic viewing pattern, the classification criteria are generated for (group 1—remaining groups), (group 2—remaining groups), . . . , (group n—remaining groups). The result generated by these classification criteria becomes whether the characteristic viewing pattern of the viewer corresponding to each group exists in the viewing history of the viewer which is authorized by the input of the classification criteria, which is similar to the concept of a filter. In the viewing history of the viewing household, the viewing histories of several viewers are mixed. It is determined whether there is a viewer having the corresponding viewing pattern through the information on whether there is a characteristic viewing pattern in the viewing history. Each classification criteria may have the same characteristic viewing pattern, and in such a case, the viewing household member profile may be deduced by excluding the characteristic viewing pattern redundant in the viewing household member profile deduction operation (S330). In the following operations, each classification criterion may be generated to exclude the characteristic viewing pattern having the same classification criterion in the operation (S230) of generating the view group classification criteria without performing the operation of excluding the characteristic viewing pattern.

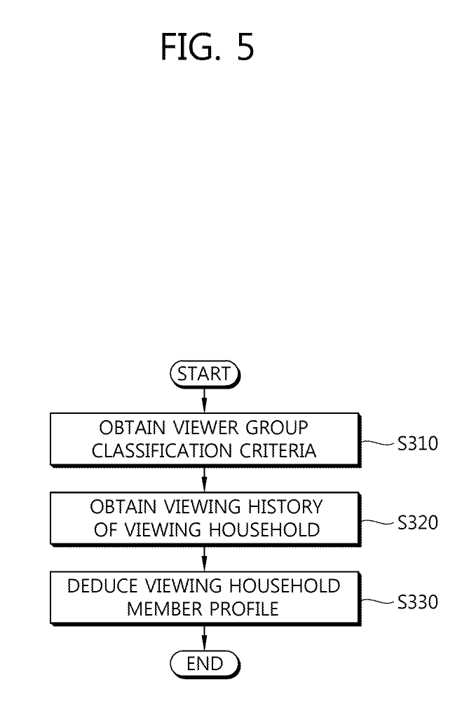

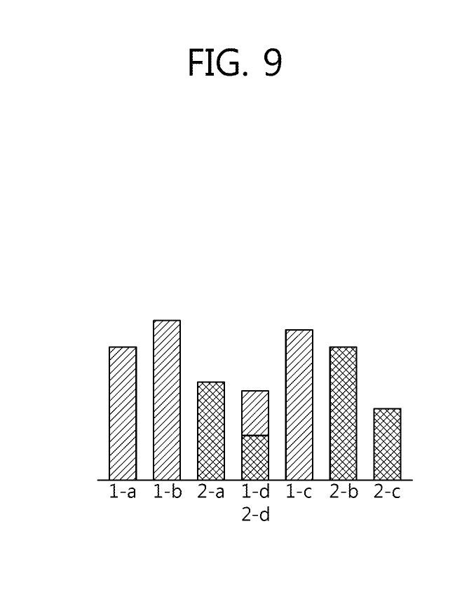

FIG. 5 is a flowchart illustrating operation of deducing a viewing household member profile of an apparatus 200 for deducing a viewing household member profile according to an embodiment of the present invention. The viewing household member profile deduction operation will be described with reference to FIG. 5. First, the viewer group classification criteria are acquired (S310). Next, the viewing history of the viewing household is obtained (S320). Lastly, the viewing household member profile is deduced (S330). FIG. 9 is a diagram illustrating a viewing pattern of a viewing household input to an apparatus for deducing a viewing household member profile according to an embodiment of the present invention.

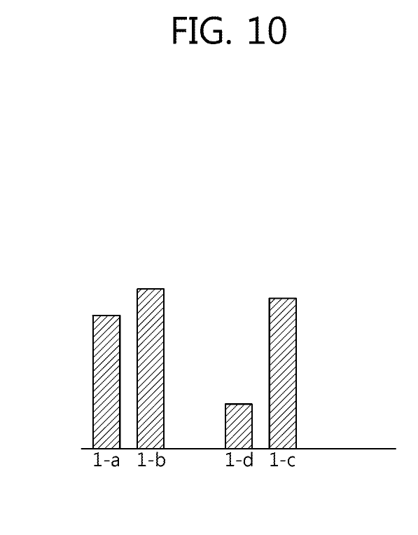

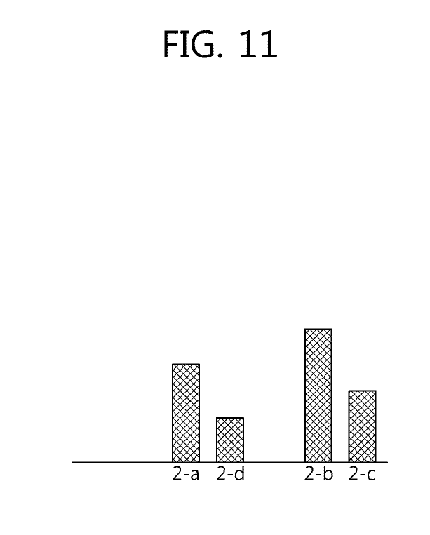

FIG. 9 illustrates an example of a viewing pattern of a viewing household including the viewer who belongs to group 1 and two viewers who belong to group 2. 1-a, 1-b, . . . , 2-a, 2-b, . . . , etc. indicate the viewing pattern attributes, and the bar graph shows the value of the attribute. FIG. 10 is a diagram illustrating a characteristic viewing pattern of viewer group 1 generated by a viewing household profile deduction apparatus 200 according to an embodiment of the present invention, and FIG. 11 is a diagram illustrating a characteristic viewing pattern of viewer group 2 generated by a viewing household profile deduction apparatus 200 according to an embodiment of the present invention. The viewing pattern of the entire viewing household as in FIG. 9 is formed by the combination of the viewing patterns of FIGS. 10 and 11.

The bar filled by oblique lines is the viewing pattern of the viewer who belongs to group 1, and the bar filled by oblique lines is the viewing pattern of the viewer who belongs to group 2. The viewing pattern of the viewer is not distinguished by individuals and the viewing history is analyzed by households, and thus it is not possible to recognize the number of viewers of a certain viewing history or to recognize the specific viewer at this stage. Furthermore, the viewing patterns of several individuals are combined, and thus when the viewing pattern of group 1 is compared with the entire viewing pattern of the viewing households, differences may be found more than similarities, thereby increasing the possibility to determine that the group is not group 1.

The viewing household member profile deduction unit 230 respectively compares whether the entire viewing pattern attribute of the viewing household of FIG. 9 is similar to the attribute of the viewing pattern of group 1 viewer of FIG. 10, and compares whether the entire viewing pattern attribute of the viewing household is similar to the attribute of the viewing pattern of group 2 of FIG. 11. The existence of the group viewer may be determined even when the viewing patterns of several individuals are combined and mixed by disregarding other attributes and comparing only the characteristics viewing pattern characteristics of respective group viewers.

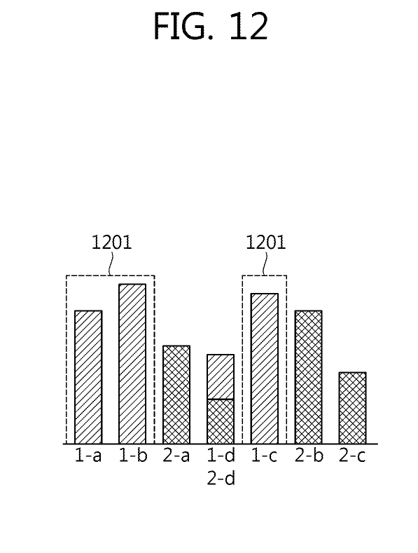

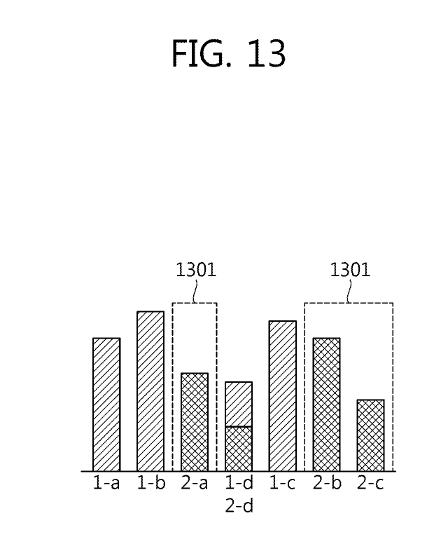

FIG. 12 is a diagram illustrating a method of applying the characteristic viewing pattern of viewer group 1 to the viewing household viewing pattern 1201 by a viewing household profile deduction apparatus 200 according to an embodiment of the present invention, and FIG. 13 is a diagram illustrating a method of applying the characteristic viewing pattern of viewer group 2 to the viewing household viewing pattern 1301 by a viewing household profile deduction apparatus 200 according to an embodiment of the present invention.

The characteristic viewing pattern attributes of group 1 are 1-a, 1-b, and 1-c, and the characteristic viewing pattern attributes of group 2 are 2-a, 2-b, and 2-c. If the classification criteria of each group are not generated not to have the viewing pattern attributes which are overlapped with another group, the viewing pattern attribute overlapped with another group may be shown. In such a case, the values by viewers of several groups are added, and the attributes may not have the characteristic values for specifying the viewer group. Some examples of such attributes are attributes of 1-d and 2-d. 1-d and 2-d are viewing patterns overlapped with another group viewer, and thus 1-d and 2-d may not have the characteristic value and may not be compared. That is, the group included in the viewing pattern may be determined using only the attributes which are not overlapped with different viewer groups, and the intensity showing the tendency of each group may be determined using the value of the attributes expressed by a bar graph. If the value of the attribute shown in the entire viewing pattern is large compared to n viewer group classification criteria, the viewers who belong to the group classification occupy a large viewing portion.

Likewise, n group viewing pattern attributes may be respective compared for the entire household viewing pattern, and thereby it is possible to recognize the viewer group included in the entire household viewing pattern among n viewer groups.

The viewing household member profile deduction apparatus 200 using a classifier which performs two operations of analyzing the viewing pattern of the sample household and generating the viewer group, and generating the viewer group classification criteria, according to an embodiment of the present invention is built using the above-described method. As such, the viewing pattern may be analyzed in the same manner as that in the sample household from the viewing history of a general viewing household whose member profile is not known. The viewing history may be collected in a two-way medium such as an IPTV. If the analyzed result is input to n second classifiers, it is determined whether the characteristic viewing pattern of the viewer who belongs to each group is included in the viewing history of the viewing household. It is deduced that the viewer corresponding to the classifiers determined to include the characteristic viewing pattern is included in the viewing household.

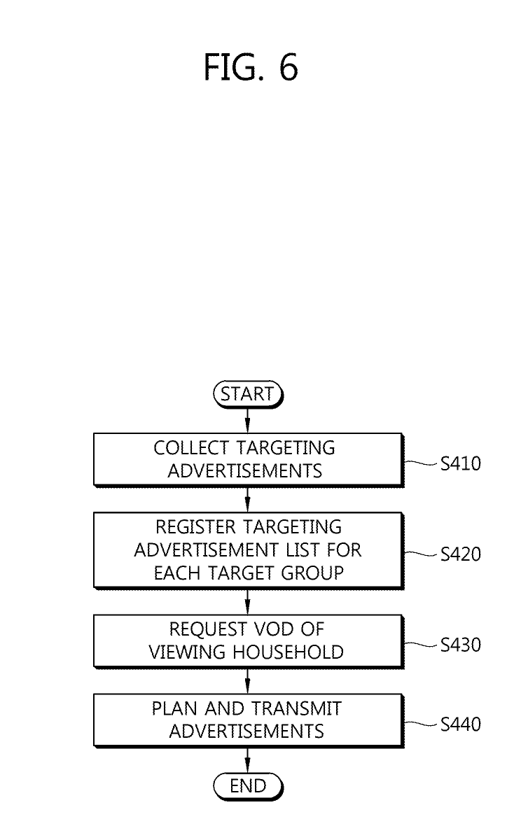

FIG. 6 is a flowchart illustrating operation of utilizing a viewing household profile of an apparatus 200 for deducing a viewing household member profile according to an embodiment of the present invention. The process of providing the targeting advertisement by the advertisement provider's prediction of the viewers may be considered. If the advertisement provider collects the targeting advertisements (S410) and registers the targeting advertisement list by target groups (S420), the viewing household's VoD may be requested according to the user of the viewer (S430). If the viewer requests a VoD, the advertiser may plan and transmit advertisements according to the viewer groups of the deduced viewers to transmit the advertisements that fit the viewers (S440).

According to a method and apparatus for deducing a viewing household member profile of the present invention, the viewing pattern of a general viewing household has been analyzed based on the viewer group classification criteria generated using the standard household member profile, and thus the member profile of the viewing household may be deduced and the deduced profile may be provided, thereby effectively providing advertisements corresponding to the inclination of viewing household members.

The combination of above-described embodiments is not limited to the above-described embodiments, and various forms of combinations may be provided as necessary.

In the above-described embodiments, the described methods have been explained abased on a flowchart as an operation or a block, but the present invention is not limited to the order of the described operations, and some operations may be performed in an order that is different from the above description or simultaneously. Furthermore, those skilled in the art would understand that the operations shown in flowcharts are not exclusive, and thus other operations may be included or one or more operations of the flowcharts may be deleted without affecting the scope of the present invention.

A person having ordinary skill in the art to which the present invention pertains may change and modify the present invention in various ways without departing from the technical spirit of the present invention. Accordingly, the present invention is not limited to the above-described embodiments and the accompanying drawings.

What is claimed is:

1. A method of deducing a member profile of a viewing household, the method comprising:
deducing the member profile of the viewing household using viewer group classification criteria.

2. The method of claim 1, wherein the deducing further comprises:
generating the viewer group classification criteria using a viewing pattern according to a viewer group.

3. The method of claim 2, wherein the deducing further comprises:
analyzing a viewing pattern performing using a viewing pattern of a viewing household whose member profile is already known.

4. The method of claim 3, wherein the analyzing comprises:
analyzing the viewing pattern of the viewer group formed by grouping viewers by profile attributes of the viewers.

5. The method of claim 2, wherein the generating comprises:
generating a difference in a viewing pattern between the viewer groups;
generating a characteristic viewing pattern of the viewer groups; and
generating the viewer group classification criteria using the characteristic viewing pattern.

6. The method of claim 5, wherein the generating the difference comprises:
generating the difference in the viewing pattern between the viewer groups by classifying the viewer groups using the viewing pattern between the viewer groups and a decision tree.

7. The method of claim 6, wherein the generating of the characteristic viewing pattern comprises:
determining common attributes shown in respective viewing pattern differences as characteristic viewing patterns in respective viewing pattern differences shown in one to one correspondence between a first viewer group and one or more other viewer groups.

8. The method of claim 5, wherein the generating of the viewer group classification criteria comprises:
generating the viewer group classification criteria of the viewer group using the characteristic viewing pattern which belongs to the viewer group and does not belong to other viewer groups.

9. The method of claim 1, wherein the deducing comprises:
deducing the member profile of the viewing household by finding viewer group classification criteria corresponding to a viewing history of the viewing household.

10. The method of claim 1, wherein the deducing the member of the viewing household comprises:
using viewing history attributes to which the two or more viewer group classification criteria are not applied among the viewing history attributes of the viewing household, as a data set for deducing the viewer profile.

11. An apparatus for deducing a member profile of a viewing household, the apparatus comprising:
a viewing household member profile generation unit that deduces the member profile of the viewing household using viewer group classification criteria.

12. The apparatus of claim 11, wherein the viewing household member profile generation unit comprises:
a viewer group classification criteria generation unit that the viewer group classification criteria according to a viewing pattern of a viewer group; and
a viewing household member profile deduction apparatus that deduces a member profile of the viewing household using the viewer group classification criteria.

13. The apparatus of claim 12, wherein the viewing household member profile generation unit further comprises:
a viewing pattern analysis unit that analyzes the viewing pattern of the viewing household using the viewing pattern of the viewing household whose member profile is already known.

14. The apparatus of claim 13, wherein the viewing pattern analysis unit comprises:
analyzing a viewing pattern of viewer groups in which viewers have been grouped according to profile attributes of the viewers.

15. The apparatus of claim 12, wherein the viewer group classification criteria generation unit generates the viewer group classification criteria using a characteristic viewing pattern of the viewer group generated using a viewing pattern difference between the viewer groups.

16. The apparatus of claim 15, wherein the viewer group classification criteria generation unit generates a difference in a viewing pattern between the viewer groups by classifying the viewer groups using the viewing pattern between the viewer groups and a decision tree.

17. The apparatus of claim 16, wherein the viewer group classification criteria generation unit determines common attributes shown in respective viewing pattern differences as characteristic viewing patterns of the viewer group in respective viewing pattern differences shown in one to one correspondence between a first viewer group and one or more other viewer groups.

18. The apparatus of claim 15, wherein the viewer group classification criteria generation unit generates the viewer group classification criteria of the viewer group using a characteristic viewing pattern which belongs to the viewer group and does not belong to other viewer groups.

19. The apparatus of claim 11, wherein the member profile deduction unit deduces the member profile of the viewing household by finding viewer group classification criteria corresponding to a viewing history of the viewing household.

20. The apparatus of claim 19, wherein the member profile deduction unit uses viewing history attributes to which the two or more viewer group classification criteria are not applied among the viewing history attributes of the viewing household, as a data set for deducing the viewer profile.
